(19) United States
(12) Patent Application Publication
(10) Pub. No.: US 2014/0017940 A1
(43) Pub. Date: Jan. 16, 2014

(54) LAYERED CONNECTOR AND METHOD OF MANUFACTURING A LAYERED CONNECTOR

(71) Applicants: Bicheng Chen, Harrisburg, PA (US); Sean Patrick McCarthy, Palmyra, PA (US); Charles Dudley Copper, Hummelstown, PA (US)

(72) Inventors: Bicheng Chen, Harrisburg, PA (US); Sean Patrick McCarthy, Palmyra, PA (US); Charles Dudley Copper, Hummelstown, PA (US)

(73) Assignee: Tyco Electronics Corporation, Berwyn, PA (US)

(21) Appl. No.: 13/546,591

(22) Filed: Jul. 11, 2012

(51) Int. Cl. H01R 13/648; H01R 43/26

(52) U.S. Cl. 439/607.02; 156/292

(57) ABSTRACT

A layered connector includes a transmission unit having a supporting dielectric cell and an exposing dielectric cell. The supporting dielectric cell has a first surface supporting a signal conductor extending to a mating end of the supporting dielectric cell. The exposing dielectric cell is laminated to the first surface such that the signal conductor is positioned between the supporting dielectric cell and the exposing dielectric cell. The exposing dielectric cell is positioned on the first surface such that a portion of the first surface at the mating end and a portion of the signal conductor is exposed for direct electrical connection of the signal conductor to a mating component.

### BACKGROUND OF THE INVENTION

The subject matter herein relates generally to layered connectors, methods of manufacturing layered connectors and systems using layered connectors.

Electrical connectors are used to interconnect various electronic components. The electrical connectors have mating interfaces that mate with other connectors or other components. Typically, connector designs include discrete metal contacts held in place by a plastic housing. Both the housings and the contacts require significant capital expense to go to production, such as tooling costs. Additionally, typical contacts have springs at mating ends that provide mechanical force to ensure engagement with the mating component. Typical contact springs do not accommodate high speed signals easily. For example, the geometries of the contacts are compromised to balance mechanical and electrical performance.

A need remains for electrical connectors that may be manufactured in a cost-effective and reliable manner.

### BRIEF DESCRIPTION OF THE INVENTION

In one embodiment, a layered connector is provided that includes a transmission unit having a supporting dielectric cell and an exposing dielectric cell. The supporting dielectric cell has a first surface supporting a signal conductor extending to a mating end of the supporting dielectric cell. The exposing dielectric cell is laminated to the first surface such that the signal conductor is positioned between the supporting dielectric cell and the exposing dielectric cell. The exposing dielectric cell is positioned on the first surface such that a portion of the first surface at the mating end and a portion of the signal conductor is exposed for direct electrical connection of the signal conductor to a mating component.

In another embodiment, a method of manufacturing a layered connector is provided that includes providing a supporting dielectric cell, depositing a signal conductor on a first surface of the supporting dielectric cell, and laminating an exposing dielectric cell to the supporting dielectric cell at the first surface. The signal conductor is between the supporting dielectric cell and the exposing dielectric cell. The exposing dielectric cell has a void at the mating end of the supporting dielectric cell such that a portion of the first surface at the mating end is exposed and a portion of the signal conductor is exposed for direct electrical connection of the signal conductor to a mating component.

In a further embodiment, a connector system is provided having a first layered connector and a second layered connector. The first layered connector includes a first transmission unit having a first supporting dielectric cell and a first exposing dielectric cell. The first supporting dielectric cell has a first surface supporting the first exposing dielectric cell and a first signal conductor positioned between the first supporting dielectric cell and the first exposing dielectric cell. The first exposing dielectric cell has a first void exposing a portion of the first surface at a mating end of the first supporting dielectric cell and exposing a portion of the first signal conductor. The second layered connector has a second transmission unit having a second supporting dielectric cell and a second exposing dielectric cell. The second supporting dielectric cell has a second surface supporting the second exposing dielectric cell and a second signal conductor positioned between the second supporting dielectric cell and the second exposing dielectric cell. The second exposing dielectric cell has a second void exposing a portion of the second surface at a mating end of the second supporting dielectric cell and exposing a portion of the second signal conductor. The first and second layered connectors are mated together such that the first surface faces the second surface and such that the first signal conductor directly engages the second signal conductor.

### BRIEF DESCRIPTION OF THE DRAWINGS

FIG. 1 illustrates a connector system formed in accordance with an exemplary embodiment showing a first layered connector poised for mating with a second layered connector.

FIG. 2 illustrates the first and second layered connectors in a mated position.

FIG. 3 is a perspective view of a layered connector formed in accordance with an exemplary embodiment.

FIG. 4 illustrates a connector system formed in accordance with an exemplary embodiment.

FIG. 5 is a cross sectional view of a layered connector shown in FIG. 4.

FIG. 6 illustrates a connector system formed in accordance with an exemplary embodiment.

FIG. 7 is a cross sectional view of a layered connector shown in FIG. 6.

FIG. 8 illustrates a connector system formed in accordance with an exemplary embodiment.

FIG. 9 is a side cross sectional view of layered connectors shown in FIG. 8.

FIG. 10 is a front cross sectional view of a layered connector shown in FIG. 8.

FIG. 11 is a front cross sectional view of a layered connector shown in FIG. 8.

FIG. 12 illustrates a connector system formed in accordance with an exemplary embodiment.

FIG. 13 is a cross sectional view of layered connectors shown in FIG. 12.

FIG. 14 is a side perspective view of a portion of a connector system formed in accordance with an exemplary embodiment.

FIG. 15 is a cross sectional view of layered connectors.

FIG. 16 illustrates a layered connector.

FIG. 17 illustrates a layered connector.

FIG. 18 illustrates a layered connector.

### DETAILED DESCRIPTION OF THE INVENTION

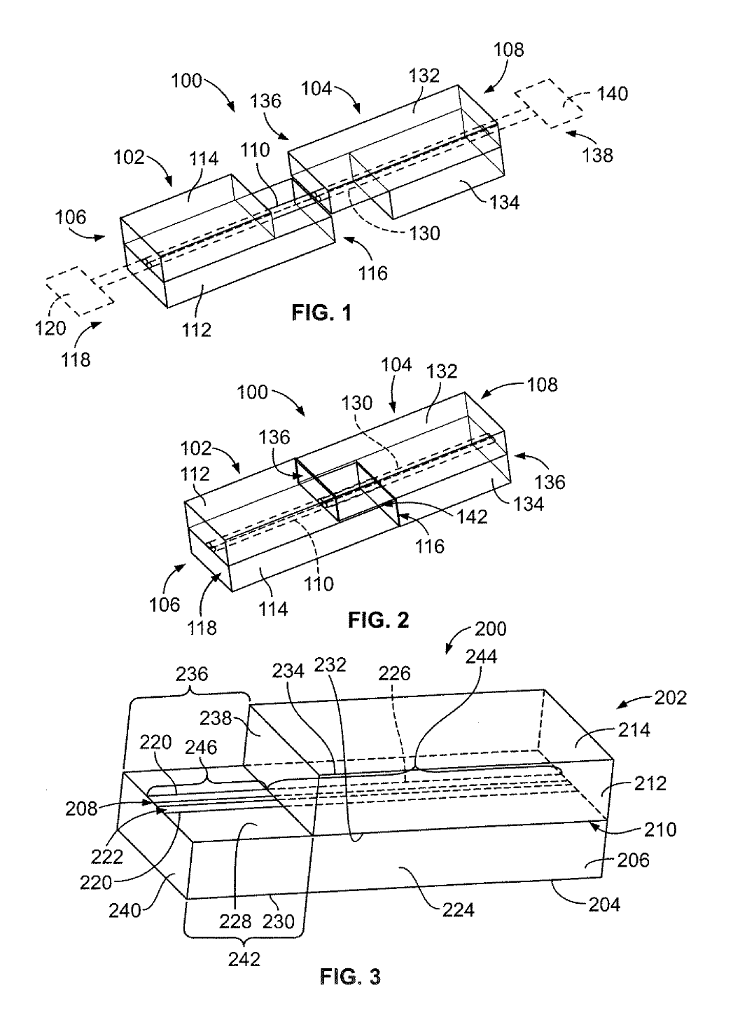

FIG. 1 illustrates a connector system 100 formed in accordance with an exemplary embodiment, showing a first layered connector 102 poised for mating with a second layered connector 104. FIG. 2 illustrates the first and second layered connectors 102, 104 in a mated position. The layered connector 104 defines a mating component for the layered connector 102, and the layered connector 102 likewise defines a mating component for the layered connector 104. The layered connectors 102, 104 are built up using a layering process, such as a laminating process. Other processes may be used to manufacture the layered connectors 102, 104 in alternative embodiments. The layered connectors 102, 104 are configured to be directly mated together without the use of other connectors therebetween. For example, edges of the layered structures directly engage one another to create an electrical connection between the layered connectors 102, 104. Optionally, the layered connectors 102, 104 may be hermaphroditic pairs inverted to be electrically connected together.

The first layered connector 102 includes one or more transmission units 106 configured to transmit data signals and/or power. The second layered connector 104 includes one or more transmission units 108 configured to transmit data signals and/or power. In an exemplary embodiment, the transmission units 106, 108 include electrical shield layering.

The first layered connector 102 includes one or more signal conductors 110 held by dielectric cells 112, 114. In the illustrated embodiment, the transmission unit 106 of the layered connector 102 includes a pair of signal conductors 110. The pair of signal conductors 110 is configured to convey differential signals between a mating end 116 and a terminating end 118. In an exemplary embodiment, the mating end 116 has a stepped edge, exposing the signal conductors 110 for mating with the layered connector 104. The mating end 116 is configured to be mated with the layered connector 104. The terminating end 118 is configured to be connected to a terminating component 120. The terminating component 120 defines a mating component for the layered connector 102. Any type of terminating component 120 may be utilized depending on the particular application. For example, the terminating component 120 may be a circuit board, a wire, a cable, an electrical connector, and the like.

The terminating component 120 is represented schematically in FIG. 1. The signal conductors 110 may be directly terminated to the terminating component 120, such as by a compression connection, a soldered connection, a crimp connection, an interference connection, a plugged connection, or another type of connection. The terminating end 118 may have exposed portions of the signal conductors 110 (similar to the mating end 116) directly connected to the terminating component 120, where such exposed portions are supported on a dielectric layer of the layered connector 102 or alternatively the exposed portions may extend beyond an edge of the layered connector 102. A separate contact or terminal may be terminated to the signal conductor 110, either interior of the layered connector 102 or at an exposed portion of the signal conductor 110. For example, a crimp barrel may be soldered to the signal conductor 110 and/or incorporated into the laminate structure of the layered connector 102 for termination to a wire or cable. Additionally, provisions may be made to terminate a electrical shield layer of the layered connector to a braided shield or ground of the cable. The layout of the signal conductors 110, such as the size, shape, spacing, and the like, at the terminating end 118 and/or the mating end 116 may be different than the covered portions of the signal conductors 110, such as to correspond to the layout of the layered connector 104 or the terminating component 120. For example, when connecting directly to an edge of a circuit board, the layout of the traces on the circuit board may be different than the layout of the signal conductors 110. The traces on the circuit board may be routed to match the layout of the signal conductors 110 and/or the signal conductors 110 may be routed to match the layout of the traces on the circuit board. Optionally, the layout of the terminating end 118 may be designed to provide characteristic impedance sensitivity for interfacing with the terminating component 120 so as to diminish signal degradation effects at such interface. For example, the spacing, thickness and other features may be controlled at the terminating end 118 to ensure appropriate signal integrity.

In an exemplary embodiment, the mating ends 116 of the signal conductors 110 are exposed for direct electrical connection with the layered connector 104. The signal conductors 110 are generally arranged as part of an internal signal layer of the layered connector 102 between the dielectric cells 112, 114. However, at the mating ends 116, the signal conductors 110 are exposed for direct electrical connection. No additional connector, contact or other mating component is needed for termination of the signal conductors 110 to the second layered connector 104. Optionally, multiple transmission units 106 may be ganged together or otherwise formed as part of a common layered connector 102 and gang terminated to the second layered connector 104 and/or the terminating component 120. Optionally, rather than mating to the layered connector 104, the layered connector 102 may be mated to another electronic component, such as a circuit board by placing the mating ends 116 in direct engagement with exposed traces on an outer surface of the circuit board.

The layered connector 104 includes one or more signal conductors 130 held by dielectric cells 132, 134. In the illustrated embodiment, the transmission unit 108 of the layered connector 104 includes a pair of signal conductors 130. The pair of signal conductors 130 is configured to convey differential signals between a mating end 136 and a terminating end 138. The mating end 136 is configured to be mated with the layered connector 102. The terminating end 138 is configured to be connected to a terminating component 140. The terminating component 140 defines a mating component for the layered connector 104. Any type of terminating component 140 may be utilized depending on the particular application. For example, the terminating component 140 may be a circuit board, a wire, a cable, an electrical connector, and the like. The terminating component 140 is represented schematically in FIG. 1.

In an exemplary embodiment, the mating ends 136 of the signal conductors 130 are exposed for direct electrical connection with the signal conductors 110 of the layered connector 102. The signal conductors 130 are generally arranged as part of an internal signal layer of the layered connector 104 between the dielectric cells 132, 134. However, at the mating ends 136, the signal conductors 130 are exposed for direct electrical connection. No additional connector, contact or other mating component is needed for termination of the signal conductors 130 to the signal conductors 110. Optionally, multiple transmission units 108 may be ganged together or otherwise formed as part of a common layered connector 104 and gang terminated to the first layered connector 102 and/or the terminating component 140.

In an exemplary embodiment, the dielectric cells 112, 114, 132, 134 may be rigid laminate materials, such as a glass epoxy material. Other material may be used in alternative embodiments. In alternative embodiments, the dielectric cells 112, 114, 132, 134 may be manufactured from a semi-rigid material, allowing the layered connectors 102, 104 to be flexible. The layered connectors 102, 104 may resemble cables being capable of being bent or manipulated to be routed to and/or from the terminating components 120, 140. The layered connectors 102, 104 may be flexible enough to bend without detrimentally distorting the cross-section and/or spacing of the signal conductors 110,130. The dielectric cells 112, 114, 132, 134 may be manufactured from a low loss dielectric.

In an exemplary embodiment, contact force between the signal conductors 110, 130 may be provided by the dielectric cells 132, 134 themselves, or alternatively, may be provided by another component, such as a clip that clamps the interface together. The clip may be used to electrically connect electrical shield layers of the layered connectors 102, 104. The clip may be used to align the layered connectors 102, 104. The mechanical force is provided by a part that is not included in the electrical current path.

When mated, as shown in FIG. 2, an air gap 142 may be defined between the layered connectors 102, 104 at the mating interfaces thereof. The air gap 142 may be defined between the surfaces of the dielectric cells 112, 134 that are exposed and face one another. The air gap 142 is formed by the signal conductors 110, 130 directly engaging one another. The surfaces of the dielectric cells 112, 134 may be held apart because the signal conductors 110, 130 are elevated from the surfaces and directly engage each other.

The air gap 142 creates a dielectric mismatch along the signal lines. Optionally, the connector system 100 may be designed such that the layered connectors 102, 104 electrically accommodate for the air gap 142. For example, the characteristic impedance of the section of the connector at the mating interfaces thereof is affected by having the signal conductors 110, 130 exposed to air along the air gap 142, as opposed to being enclosed by dielectric material, as is the case through the bulk of the connectors 102, 104 with the covered portions of the signal conductors 110, 130, which are encased between the dielectric cells 112, 114 and the dielectric cells 132, 134, respectively.

Impedance mismatch may be accommodated for by selecting a material for the dielectric cells 112, 114 and/or the dielectric cells 132, 134 with a dielectric constant that achieves similar characteristic impedance along the covered and uncovered portions. Optionally, the dielectric cells 112, 114, 132, 134 may have a dielectric constant of approximately 4. Optionally, the dielectric cells 112, 114, 132, 134 may have a dielectric constant of between approximately 3 and 5. Optionally, the dielectric cells 112, 114, 132, 134 may have a dielectric constant less than 4. In an exemplary embodiment, the signal conductors 110, 130 have covered portions and uncovered portions, where the uncovered portions are configured to be directly engaged and where the covered portions are covered by dielectric material having a dielectric constant selected to achieve similar characteristic impedance along the covered and uncovered portions of the signal conductors 110, 130.

Impedance mismatch may be accommodated for by designing the layered connectors 102, 104 to achieve a particular width and height for the air gap 142 that allows for similar characteristic impedance along the covered and uncovered portions of the signal conductors 110, 130. Signal conductor surface area variations may compensate for the changes in characteristic impedance.

FIG. 3 is a perspective view of a layered connector 200 formed in accordance with an exemplary embodiment. The layered connector 200 may be similar to the layered connectors 102, 104 (shown in FIGS. 1 and 2). The layered connector 200 includes a transmission unit 202 configured to convey power and/or data signals. In an exemplary embodiment, the layered connector 200 is a layered structure built up during a manufacturing process.

The layered connector 200 includes a first electrical shield layer 204, a first dielectric layer 206, a signal layer 208, an adhesive layer 210, a second dielectric layer 212 and a second electrical shield layer 214. The electrical shield layers 204, 214 may define ground layers, and may be referred to herein after as ground layers 204, 214. The electrical shield layers 204, 214 may define return current paths. The adhesive layer 210 is positioned between the first and second dielectric layers 206, 212 to secure the first and second dielectric layers 206, 212 together. For example, the first and second dielectric layers 206, 212 may be laminated together using the adhesive layer 210.

The signal layer 208 is disposed between the first and second dielectric layers 206, 212. The signal layer 208 is an internal signal layer between the first and second dielectric layers 206, 212. The ground layers 204, 214 provide electrical shield layering for the signal layer 208. The signal layer 208 is positioned between the first and second ground layers 204, 214 and the first and second ground layers 204, 214 are separated from the signal layer 208 by the dielectric layers 206, 212.

In an exemplary embodiment, the signal layer 208 is defined by one or more signal conductors 220. In the illustrated embodiment, two signal conductors 220 are provided, however the layered connector 200 may have any number of signal conductors 220 within the transmission unit 202. The signal conductors 220 may be arranged in any shape to ensure the connector interface reaches certain electrical specifications. In an exemplary embodiment, the signal conductors 220 are deposited on the first dielectric layer 206. For example, the signal conductors 220 may be copper circuit traces deposited on the first dielectric layer 206 and/or the second dielectric layer 212. A thickness, width, length, shape and/or spacing of the signal conductors 220 may be controlled to achieve a desired electrical characteristic, such as characteristic impedance, current carrying capability, resistance, thermal effects, and the like, depending on the particular application. Optionally, the signal conductors 220 may extend along linear paths. Alternatively, the signal conductors 220 may extend along nonlinear paths. In an exemplary embodiment, the signal conductors 220 are exposed at mating ends 222 of the signal conductors 220 for direct electrical connection of the signal conductors 220 to a corresponding structure, such as signal conductors of another layered connector.

The layered connector 200 includes a first dielectric cell 224 and a second dielectric cell 226. In the illustrated embodiment, the first dielectric cell 224 constitutes a supporting dielectric cell and may be referred to hereinafter as a supporting dielectric cell 224. In the illustrated embodiment, the second dielectric cell 226 constitutes an exposing dielectric cell, and may be referred to hereinafter as an exposing dielectric cell 226. The supporting dielectric cell 224 supports the signal conductors 220. The exposing dielectric cell 226 is stepped at the mating end to expose internal layers of the layered connector 200, such as the signal layer 208. The exposing dielectric cell 226 exposes the mating ends 222 of the signal conductors 220. The exposing dielectric cell 226 exposes a first surface 228 of the supporting dielectric cell 224. Optionally, the layered connector 200 may be inverted or rotated approximately 180° about the longitudinal axis, in which case the signal conductors 220 could be supported by the second dielectric cell 226, and such dielectric cell 226 could constitute a supporting dielectric cell and may be referred to hereinafter as a supporting dielectric cell 226. Additionally, it is realized that the signal conductors 220 may be supported from above by either dielectric cell 224, 226, and as such both dielectric cells 224, 226 constitute supporting dielectric cells.

The supporting dielectric cell 224 may be manufactured from a dielectric material, such as an FR4 material, glass epoxy material, a synthetic material, a plastic material, and the like. The supporting dielectric cell 224 may be manufactured from a planar dielectric sheet, and may be cut or separated from the planar dielectric sheet as part of a manufacturing process.

In an exemplary embodiment, the signal conductors 220 are deposited on to the first surface 228. For example, copper sheets may be laminated onto the first surface 228 and etched to form the circuits. Other depositing techniques may be used in alternative embodiments, such as printing the signal conductors 220 on the first surface 228. The signal conductors 220 may be manufactured from copper, aluminum or any other suitable metallic or conductive material. The supporting dielectric cell 224 includes a second surface 230 opposite the first surface 228. The first ground layer 204 is provided on the second surface 230. Optionally, the first ground layer 204 may be deposited directly on the second surface 230. For example, the first ground layer 204 may be plated or otherwise deposited on the second surface 230. Alternatively, a copper sheet may be laminated to the second surface 230 to define the first ground layer 204. A thickness of the supporting dielectric cell 224 may be selected to control the distance between the first ground layer 204 and the signal conductors 220.

The exposing dielectric cell 226 is manufactured from a dielectric material. The exposing dielectric cell 226 is deposited on the supporting dielectric cell 224. For example, the adhesive layer 210 may be defined by an epoxy or resin sheet (not shown) positioned on the first surface 228. The exposing dielectric cell 226 is stacked on the adhesive sheet and laminated to the supporting dielectric cell 224. The exposing dielectric cell 226 may be manufactured from a planar dielectric sheet that is deposited on the planar dielectric sheet defining the supporting dielectric cell 224.

The exposing dielectric cell 226 includes a first surface 232 that faces the first surface 228 of the supporting dielectric cell 224. The exposing dielectric cell 226 includes a second surface 234 opposite the first surface 232. The second dielectric layer 212 is deposited on the second surface 234. For example, the second surface 234 may be covered by a copper sheet laminated on the second surface 234. The copper sheet defines the second ground layer 214. After the planar dielectric sheets are laminated, the dielectric cells 224, 226 may be separated from the sheets, such as by cutting the dielectric cells 224, 226.

The exposing dielectric cell 226 exposes a portion of the first surface 228 of the supporting dielectric cell 224 and exposes portions of the signal conductors 220 that define the mating ends 222. In an exemplary embodiment, a void 236 is defined forward of a recessed mating edge 238 of the exposing dielectric cell 226. The recessed mating edge 238 is recessed rearward with respect to a mating edge 240 of the supporting dielectric cell 224. The void 236 exposes the first surface 228 and the mating ends 222 of the signal conductors 220 for direct connection to a corresponding mating component (not shown), such as the layered connector 104 (shown in FIG. 1). Optionally, the mating component may be positioned in close proximity, including direct physical contact, with the recessed mating edge 238 to reduce the air gap between the surfaces, such as to reduce dielectric discontinuity. The void 236 may have any size or shape depending on their particular application. In an exemplary embodiment, the void 236 is formed by removing a portion of the exposing dielectric cell 226. For example, during the manufacturing processing, a portion of the exposing dielectric cell 226 may be cut, such as laser cut, CNC routing, screening, and the like, from the planar dielectric sheet (or the exposing dielectric cell 226 if already separated from the planar dielectric sheet). In alternative embodiments, a portion of the exposing dielectric cell 226 may be removed by milling or grinding the second dielectric cell 226. Optionally, the cut edge is of sufficiently high quality to ensure signal integrity of the signal conductors 220 by reducing dielectric discontinuity at the interface.

The supporting dielectric cell 224 includes a finger 242 aligned with the void 236. The finger 242 extends to the mating edge 240. The finger 242 defines a mating end of the supporting dielectric cell 224 and may be referred to hereinafter as a mating end 242. The finger 242 defines the exposed portion of the first surface 228. The finger 242 is the uncovered portion of the supporting dielectric cell 224.

In an exemplary embodiment, the signal conductors 220 include covered portions 244 and uncovered portions 246. The covered portions 244 are the portions of the signal conductors 220 between the first and second dielectric cells 224, 226. The uncovered portions 246 are the portions of the signal conductors 220 that are exposed on the first surface 228 beyond the recessed mating edge 238 of the exposing dielectric cell 226. The uncovered portions 246 are the portions defining the mating ends 222. The uncovered portions 246 are configured to be directly electrically connected to corresponding signal conductors of the mating component.

In an exemplary embodiment, the uncovered portions 246 extend to, or proximate to, the mating edge 240. Optionally, the mating ends 222 and/or the first surface 228 at the mating edge 240 may be chamfered or have a lead-in to guide mating with the mating component and/or to prevent stubbing or damage to the signal conductors 220 during mating with the mating component.

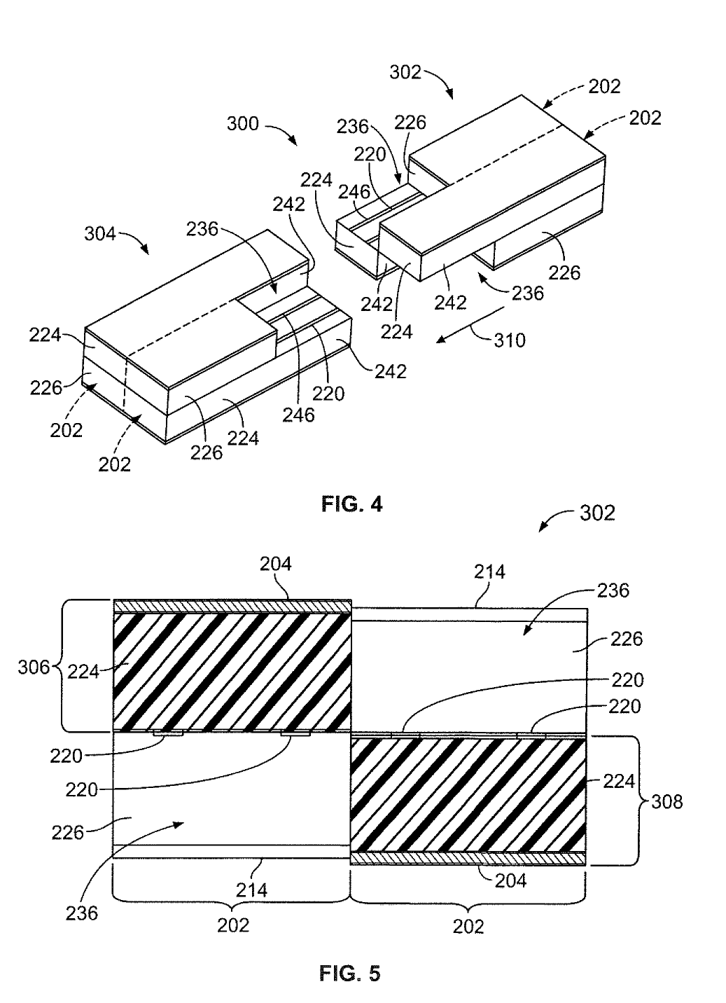

FIG. 4 illustrates a connector system 300 formed in accordance with an exemplary embodiment, showing a first layered connector 302 poised for mating with a second layered connector 304. The layered connectors 302, 304 are built up using a layering process, such as a laminating process. The layered connectors 302, 304 may be similar to the layered connector 200, however the layered connectors 302, 304 have more signal conductors. In an exemplary embodiment, the layered connectors 302, 304 are built-up using the structure of the layered connector 200 as a building block. The layered connectors 302, 304 include similar features and structures as the layered connector 200 and like features and structures will be identified with like reference numerals.

The layered connector 304 may be manufactured in a similar manner as the layered connector 302. Only the layered connector 302 will be described in detail below, with additional reference to FIG. 5, however the layered connector 304 includes similar features and components, and like features and components may be identified with like reference numerals.

FIG. 5 is a cross sectional view of the layered connector 302. In the illustrated embodiment, the layered connector 302 includes two transmission units 202 as part of the common layered connector 302. The two transmission units 202 are stacked adjacent one another. The two transmission units 202 are arranged horizontally. The two transmission units 202 are inverted or oriented 180° with respect to one another. For example, the supporting dielectric cell 224 of one transmission unit 202 (illustrated on the right) is on the bottom of the layered connector 302, while the supporting dielectric cell 224 of the other transmission unit 202 (illustrated on the left) is on the top of the layered connector 302. Similarly, the exposing dielectric cell 226 of one transmission unit 202 (illustrated on the right) is on the top of the layered connector 302, while the exposing dielectric cell 226 of the other transmission unit 202 (illustrated on the left) is on the bottom of the layered connector 302.

Other configurations are possible in alternative embodiments. For example, both supporting dielectric cells 224 may be on the top or on the bottom, while both exposing dielectric cells 226 may be on the bottom of on the top. Any number of transmission units 202 may be stacked horizontally.

In an exemplary embodiment, both transmission units 202 may be integrally formed. For example, the layered connector 302 may include a first planar dielectric sheet 306 on a bottom of the layered connector 302 and a second planar dielectric sheet 308 on a top of the layered connector 302. The lower supporting dielectric cell 224 of one transmission unit 202 (illustrated on the right) and the lower exposing dielectric cell 226 of the other transmission unit 202 (illustrated on the left) may be part of the common dielectric sheet 306. The upper supporting dielectric cell 224 of one transmission unit 202 (illustrated on the left) and the upper exposing dielectric cell 226 of the other transmission unit 202 (illustrated on the right) may be part of the common dielectric sheet 308. The lower supporting dielectric cell 224 of one transmission unit 202 (illustrated on the right) and the lower exposing dielectric cell 226 of the other transmission unit 202 (illustrated on the left) may be part of the common dielectric sheet 306.

The voids 236 of the exposing dielectric cells 226 may be removed from the dielectric sheets 306, 308 either prior to or post lamination of the dielectric sheets 306, 308, thus exposing the signal conductors 220. The ground layers 204, 214 may be formed as common sheets laminated or otherwise deposited on the dielectric sheets 306. For example, on the upper surface, the ground layer 204 on the supporting dielectric cell 224 and the ground layer 214 on the exposing dielectric cell 226 may be part of a common sheet of copper that is laminated or otherwise deposited on the upper dielectric cells 224, 226. Similarly, on the lower surface, the ground layer 204 on the supporting dielectric cell 224 and the ground layer 214 on the exposing dielectric cell 226 may be part of a common sheet of copper that is laminated or otherwise deposited on the lower dielectric cells 224, 226.

With additional reference back to FIG. 4, during mating, the layered connectors 302, 304 are aligned with each other such that supporting dielectric cells 224 of the layered connector 302 are aligned with exposing dielectric cells 226 of the layered connector 304 and such that supporting dielectric cells 224 of the layered connector 304 are aligned with exposing dielectric cells 226 of the layered connector 302. The layered connectors 302, 304 are mated in a mating direction 310. The signal conductors 220 of both layered connectors 302, 304 are directly electrically coupled together. For example, the fingers 242 of the layered connector 302 fit into the voids 236 of the layered connector 304 such that the exposed or uncovered portions 246 of the signal conductors 220 of the layered connector 302 directly engage the exposed or uncovered portions 246 of the signal conductors 220 of the layered connector 304. Similarly, the fingers 242 of the layered connector 304 fit into the voids 236 of the layered connector 302 such that the exposed or uncovered portions 246 of the signal conductors 220 of the layered connector 304 directly engage the exposed or uncovered portions 246 of the signal conductors 220 of the layered connector 302.

The layered connectors 302, 304 are interlocked when mated. The interaction between the fingers 242 helps to ensure lateral alignment and accommodate for any lateral misalignment during mating. Dimensional interference between the supporting dielectric cells 224 of the layered connectors 302, 304 may be controlled to establish necessary contact forces for the signal conductor interface. In an exemplary embodiment, having the transmission units 202 inverted provides opposing vertical forces on the fingers 242 to press the fingers 242 against one another. Such pressure ensures that the uncovered portions 246 of the signal conductors 220 are pressed against each other and maintain an electrical connection therebetween. Having the mechanical clamping force provided by the dielectric cells 224 separates the mechanical function from the electrical current path, allowing the signal conductors to be designed to enhance electrical performance.

Optionally, the layered connectors 302, 304 may include ground conductors on the same layer as the signal conductors 220. For example, individual signal conductors 220 or pairs of signal conductors 220 may be flanked by ground conductors to provide electrical shield layering in the signal plane.

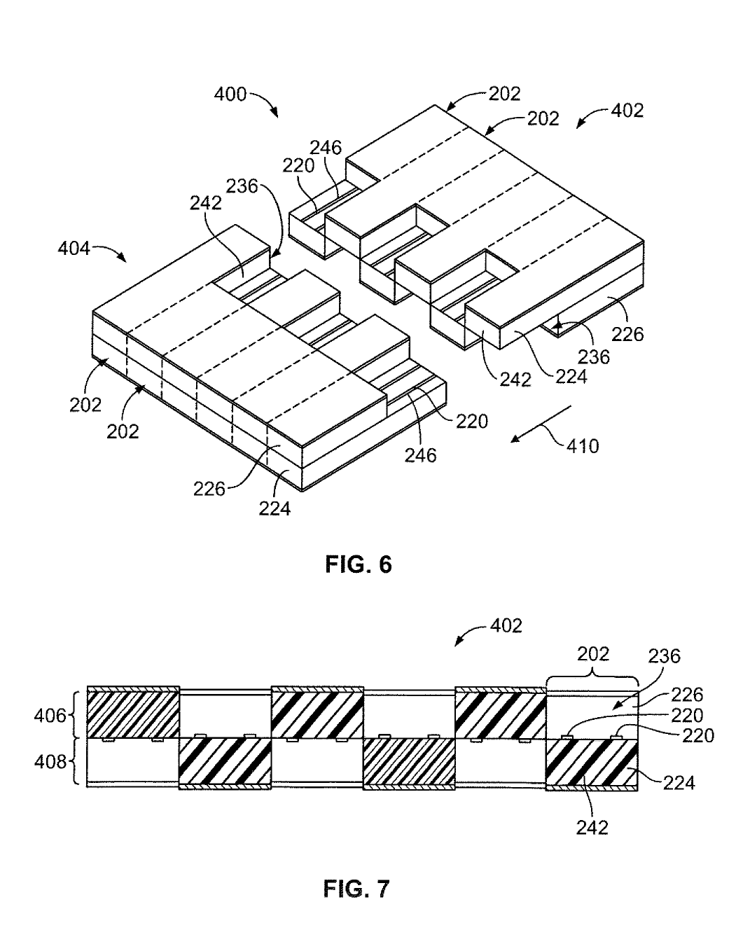

FIG. 6 illustrates a connector system 400 formed in accordance with an exemplary embodiment, showing a first layered connector 402 poised for mating with a second layered connector 404. The layered connectors 402, 404 are built up using a layering process, such as a laminating process. The layered connectors 402, 404 may be similar to the layered connectors 302, 304, however the layered connectors 402, 404 have more signal conductors 220 and more transmission units 202 stacked together. In an exemplary embodiment, the layered connectors 402, 404 are built-up using the structure of the layered connector 200 as a building block. The layered connectors 402, 404 include similar features and structures as the layered connector 200 and like features and structures will be identified with like reference numerals.

The layered connector 404 may be manufactured in a similar manner as the layered connector 402. Only the layered connector 402 will be described in detail below, with additional reference to FIG. 7, however the layered connector 404 includes similar features and components, and like features and components may be identified with like reference numerals.

FIG. 7 is a cross sectional view of the layered connector 402. In the illustrated embodiment, the layered connector 402 includes six transmission units 202 as part of the common layered connector 402. Any number of transmission units 202 may be stacked together in alternative embodiments. The six transmission units 202 are arranged horizontally. The six transmission units 202 are inverted or oriented 180° in an alternating sequence. Other configurations are possible in alternative embodiments. For example, all of the supporting dielectric cells 224 may be on the top or on the bottom, while all of the exposing dielectric cells 226 may be on the bottom of on the top.

In an exemplary embodiment, all of the transmission units 202 are integrally formed. For example, the layered connector 402 may include a first planar dielectric sheet 406 on a bottom of the layered connector 402 and a second planar dielectric sheet 408 on a top of the layered connector 402. The dielectric sheet 406 includes both supporting dielectric cells 224 and exposing dielectric cells 226. The dielectric sheet 408 includes both supporting dielectric cells 224 and exposing dielectric cells 226. In alternative embodiments, rather than being integrally formed, individual transmission units 202 or groups of transmission units 202, may be coupled together, such as by laminating, fastening, clipping, loading into a common housing, and the like.

With additional reference back to FIG. 6, during mating, the layered connectors 402, 404 are aligned with each other such that supporting dielectric cells 224 of the layered connector 402 are aligned with exposing dielectric cells 226 of the layered connector 404 and such that supporting dielectric cells 224 of the layered connector 404 are aligned with exposing dielectric cells 226 of the layered connector 402. The layered connectors 402, 404 are mated in a mating direction 410. The signal conductors 220 of both layered connectors 402, 404 are directly electrically coupled together. The fingers 242 of the layered connectors 402 are interdigitated when mated. The fingers 242 of the layered connector 402 fit into the voids 236 of the layered connector 404 such that the exposed or uncovered portions 246 of the signal conductors 220 of the layered connector 402 directly engage the exposed or uncovered portions 246 of the signal conductors 220 of the layered connector 404. Similarly, the fingers 242 of the layered connector 404 fit into the voids 236 of the layered connector 402 such that the exposed or uncovered portions 246 of the signal conductors 220 of the layered connector 404 directly engage the exposed or uncovered portions 246 of the signal conductors 220 of the layered connector 402.

In an exemplary embodiment, having the transmission units 202 inverted and alternating provides opposing vertical forces on the fingers 242 to press the forgers 242 against one another. Such pressure ensures that the uncovered portions 246 of the signal conductors 220 are pressed against each other and maintain an electrical connection therebetween.

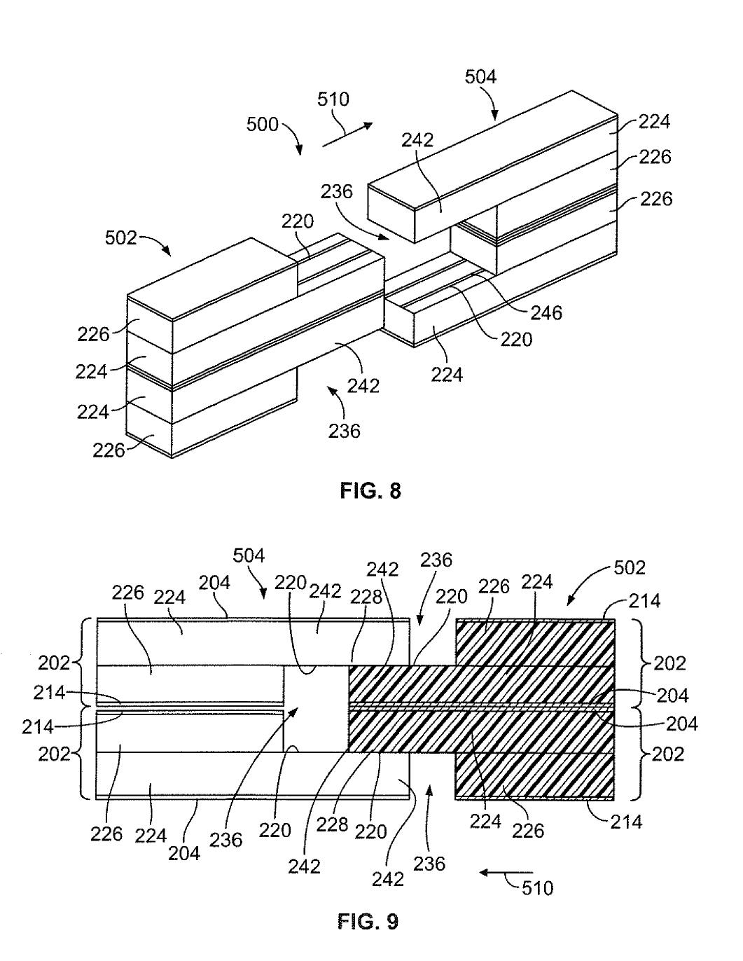

FIG. 8 illustrates a connector system 500 formed in accordance with an exemplary embodiment, showing a first layered connector 502 poised for mating with a second layered connector 504. The layered connectors 502, 504 are built up using a layering process, such as a laminating process. The layered connectors 502, 504 may be similar to the layered connector 200, however the layered connectors 502, 504 have more transmission units 202. In an exemplary embodiment, the layered connectors 502, 504 are built-up using the structure of the layered connector 200 as a building block. The layered connectors 502, 504 include similar features and structures as the layered connector 200 and like features and structures will be identified with like reference numerals.

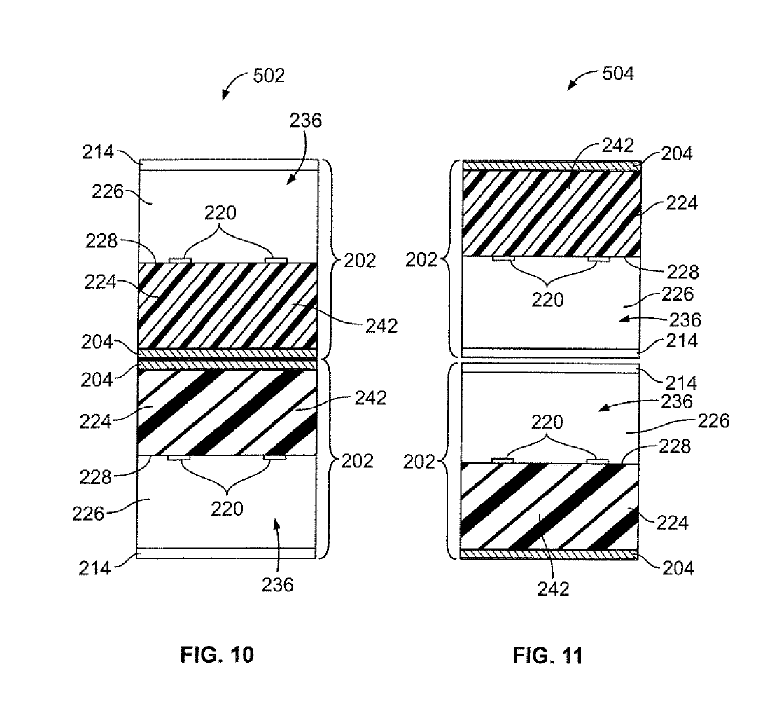

FIG. 9 is a side cross sectional view of the layered connectors 502, 504. FIG. 10 is a front cross sectional view of the layered connector 502. FIG. 11 is a front cross sectional view of the layered connector 504.

In the illustrated embodiment, the layered connector 502 includes two transmission units 202 as part of the common layered connector 502. The two transmission units 202 are stacked adjacent one another. The two transmission units 202 are arranged vertically. Optionally, shielding may be provided along one or both sides of the layered connectors 502, 504 to provide shielding form other adjacent layered connectors 502, 504 or other electronic components.

In the illustrated embodiment, the two transmission units 202 are inverted or oriented 180° with respect to one another. For example, the supporting dielectric cells 224 of the transmission units 202 are stacked on each other in the middle of the layered connector 502, while the exposing dielectric cells 226 are on the top and bottom of the layered connector 502. The layered connector 504 has the opposite configuration of the supporting dielectric cells 224 of the transmission units 202 on the top and bottom of the layered connector 504, while the exposing dielectric cells 226 are stacked at the middle of the layered connector 504. Other configurations are possible in alternative embodiments. Any number of transmission units 202 may be stacked vertically.

For the layered connector 502, both transmission units 202 are connected together, such as by laminating the two transmission units 202 together. For example, the ground layers 204 of the supporting dielectric cells 224 may be laminated or otherwise connected together, such as by soldering. The first surfaces 228 of the supporting dielectric cells 224 and the corresponding signal conductors 220 thereon face in opposite directions.

For the layered connector 504, both transmission units 202 are connected together, such as by laminating the two transmission units 202 together. For example, the ground layers 214 of the exposing dielectric cells 226 may be laminated or otherwise connected together, such as by soldering. The first surfaces 228 of the supporting dielectric cells 224 and the corresponding signal conductors 220 thereon face each other across the voids 236 of the two exposing dielectric cells 226.

With additional reference back to FIG. 8, during mating, the layered connectors 502, 504 are aligned with each other such that supporting dielectric cells 224 of the layered connector 502 are aligned with the exposing dielectric cells 226 of the layered connector 504 and such that supporting dielectric cells 224 of the layered connector 504 are aligned with the exposing dielectric cells 226 of the layered connector 502. The layered connectors 502, 504 are mated in a mating direction 510. The signal conductors 220 of both layered connectors 502, 504 are directly electrically coupled together. For example, the fingers 242 of the layered connector 502 fit into the voids 236 of the layered connector 504 such that the exposed or uncovered portions 246 of the signal conductors 220 of the layered connector 502 directly engage the exposed or uncovered portions 246 of the signal conductors 220 of the layered connector 504. Similarly, the fingers 242 of the layered connector 504 fit into the voids 236 of the layered connector 502 such that the exposed or uncovered portions 246 of the signal conductors 220 of the layered connector 504 directly engage the exposed or uncovered portions 246 of the signal conductors 220 of the layered connector 502. In an exemplary embodiment, the supporting dielectric cells 224 of the layered connector 504 provide opposing vertical forces on the fingers 242 of the layered connector 502 to press the uncovered portions 246 of the signal conductors 220 against each other to maintain an electrical connection therebetween.

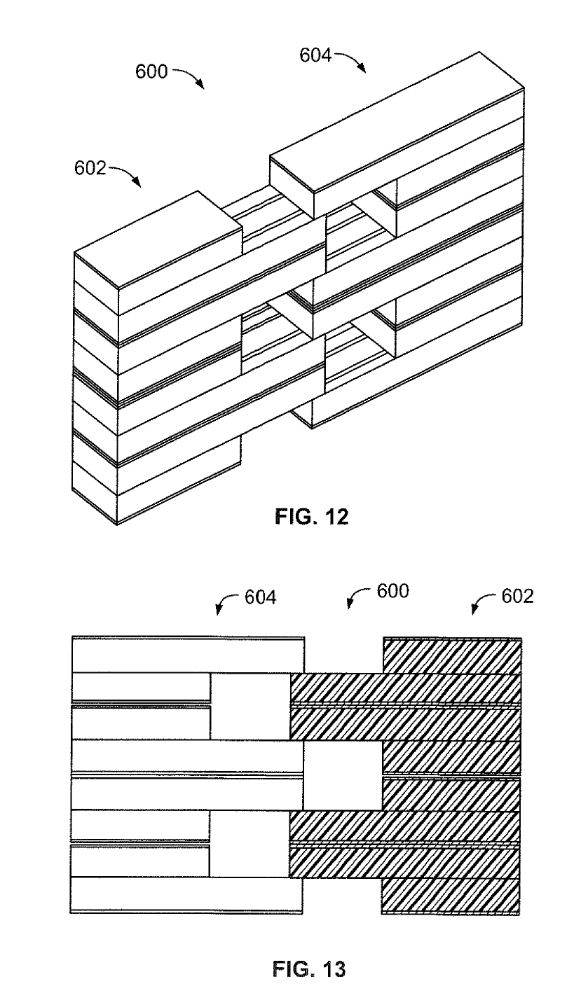

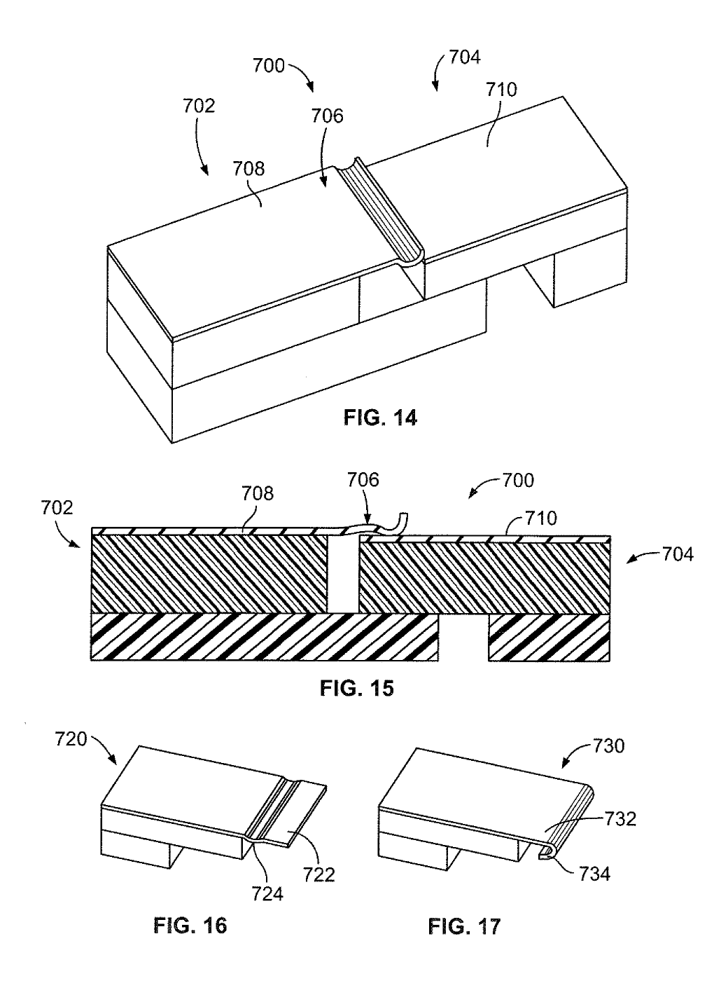

FIG. 12 illustrates a connector system 600 formed in accordance with an exemplary embodiment, showing a first layered connector 602 poised for mating with a second layered connector 604. FIG. 13 is a cross sectional view of the first and second layered connectors 602, 604. The layered connectors 602, 604 are built up using a layering process, such as a laminating process. The layered connectors 602, 604 may be similar to the layered connectors 502, 504, however the layered connectors 602, 604 have more transmission units 202. Any number of transmission units 202 may be used in other embodiments. The transmission unit 202 defines a basic cell used as a building block design to produce multiple I/O connectors. The horizontal stacking and vertical stacking are two examples that utilize the basic building block to produce multiple I/O connectors. Other embodiments may include multiple transmission units 202 per layer and may include multiple layers per connector. For example, some connectors may have both horizontal and vertical stacking.

FIG. 14 is a side perspective view of a portion of a connector system 700 formed in accordance with an exemplary embodiment, showing a first layered connector 702 poised for mating with a second layered connector 704. FIG. 15 is a cross sectional view of the first and second layered connectors 702, 704. The layered connectors 702, 704 are built up using a layering process, such as a laminating process. The layered connectors 702, 704 may be similar to the layered connector 200, however the layered connector 702 includes a ground bridge 706 extending forward from an electrical shield or ground layer 708 of the layered connector 702. The ground bridge 706 is configured to engage and be electrically connected to an electrical shield or ground layer 710 of the layered connector 704 to electrically common the ground layers 708, 710. The ground bridge 706 is deflectable and may be biased against the ground layer 710 when the layered connectors 702, 704 are mated together. The ground bridge 706 has a curved bottom to ensure contact with the ground layer 710 as the ground bridge 706 is deflected.

FIG. 16 illustrates a layered connector 720 similar to the layered connector 702, however the layered connector 720 has a ground bridge 722 having a different shape. The ground bridge 722 includes a dimple or crease 724 that extends downward to ensure electrical contact with a corresponding ground layer when mated thereto.

FIG. 17 illustrates a layered connector 730 similar to the layered connector 702, however the layered connector 730 has a ground bridge 732 having a different shape. The ground bridge 732 includes a folded end 734 that extends downward to ensure electrical contact with a corresponding ground layer when mated thereto.

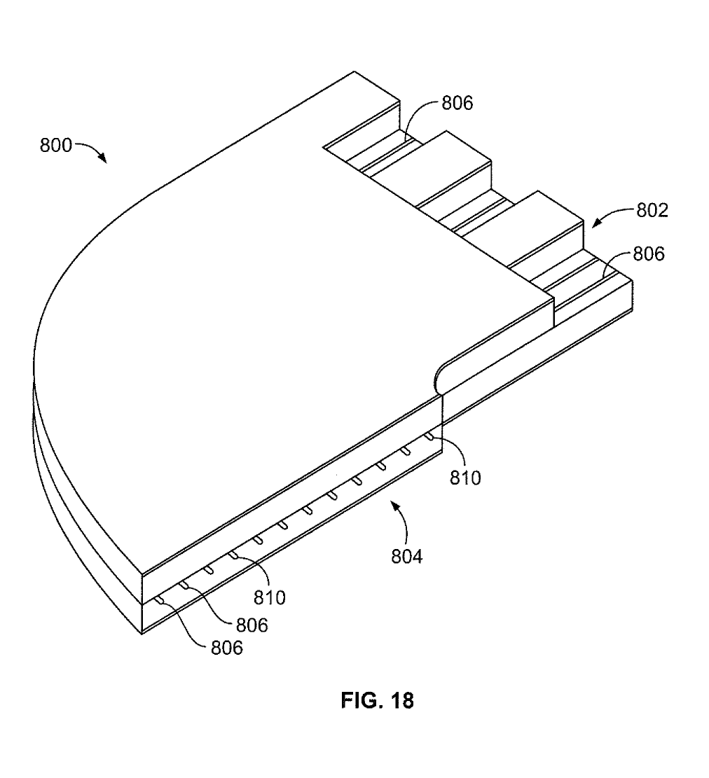

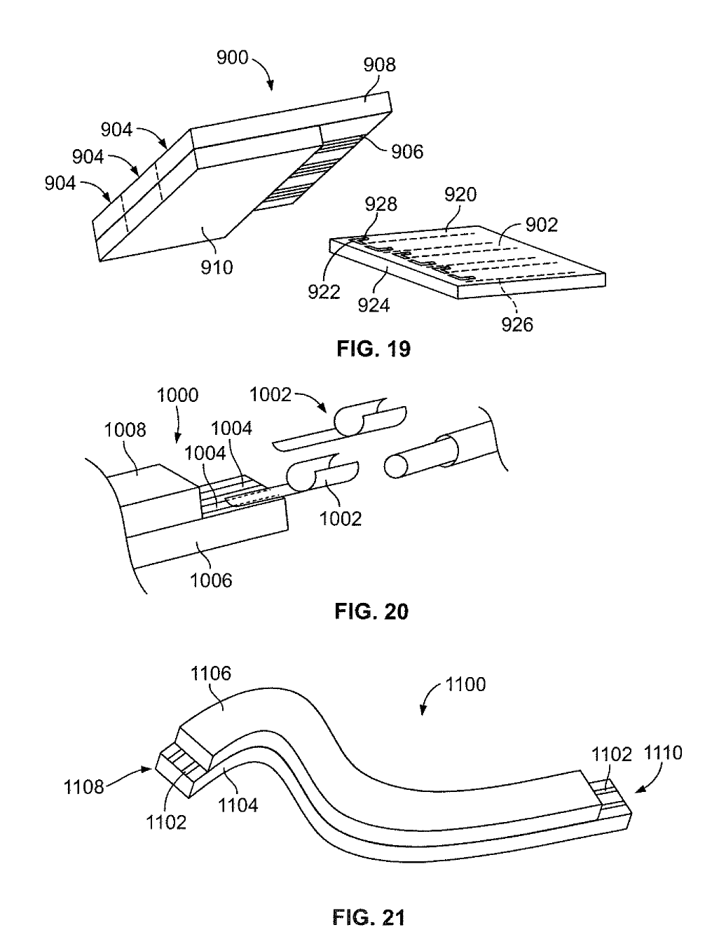

FIG. 18 illustrates a layered connector 800 similar to the layered connector 402, however the layered connector 800 has a different shape. The layered connector 800 defines a right angle connector. The layered connector 800 has a mating end 802 and a terminating end 804. Signal conductors 806 extend between the mating and terminating ends 802, 804. The signal conductors 806 are exposed at the mating end 802 for direct electrical connection to a mating component, such as the layered connector 404 (shown in FIG. 6). The signal conductors 806 have pins 810 at the terminating end 804 for termination to a circuit board. For example, the pins 810 may be through-hole mounted to corresponding vias in a circuit board. Other types of interfaces may be provided at the terminating end 804 for termination of the signal conductors 806, including interfaces for surface mounting to a circuit board, terminating to wires or cables, terminating to a connector, such as a straddle mount connector, a surface mount connector or another type of connector.

FIG. 19 illustrates a layered connector 900 poised for terminating to a circuit board 902. The layered connector 900 includes a plurality of transmission units 904, however a single transmission unit may be used in alternative embodiments. Each transmission unit 904 includes at least one signal conductor 906. In the illustrated embodiment, each transmission unit 904 includes a pair of signal conductors 906. The layered connector 900 is stepped at a mating end 906 for mating directly to the circuit board 902. The layered connector 900 includes a supporting dielectric cell 908 and an exposing dielectric cell 910, which may be defined by sheets of dielectric material laminated together or alternatively may be individual cells that are coupled together. The signal conductors 906 are deposited on the supporting dielectric cell 908.

The circuit board 902 has a mating surface 920, which is an outer surface of the circuit board 902. The mating surface 920 has signal pads 922 exposed proximate to an edge 924 of the circuit board 902. The signal pads 922 are connected to traces 926 (shown in phantom) routed through internal layers of the circuit board 902. The traces 926 are connected to the signal pads 922 by vias 928. The signal pads 922 are arranged for mating to the signal conductors 906. The pitch or spacing of the signal pads 922 may be different than the traces 926 to ensure that the signal pads 922 are aligned with the signal conductors 906 for direct electrical connection. The electrical connection is a compressible connection and a secondary component, such as a clip, may be provided to impart the mechanical force to maintain the connection therebetween.

The layered connector 900 is designed such that the signal conductors 906 directly engage the signal pads 922 of the circuit board 902. The spacing of the signal conductors 906, along the exposed portions thereof, are arranged to complement the arrangement of the signal pads 922 to ensure that the signal conductors 906 are aligned with the signal pads 922 for direct electrical connection. The signal conductors 906 themselves make the direct electrical connection to the signal pads 922 (which may be accomplished with solder as opposed to a compression connection), as opposed to providing a via through one of the dielectric cells 908 and/or 910 to an outer surface of such dielectric cell 908, 910 for mating. Such an arrangement has better electrical performance than an arrangement that uses vias to bring the conductors to an outer surface of the connector.

FIG. 20 illustrates a layered connector 1000 having a terminal 1002. The terminal 1002 is represented by a crimp barrel configured to be crimped to an end of a cable 1004. Other types of terminals 1002 may be provided in alternative embodiments. The terminal 1002 is electrically connected to a corresponding signal conductor 1004. The signal conductor 1004 is provided between dielectric cells 1006, 1008. The terminal 1002 may be incorporated into one or more of the dielectric cells, such as by having a portion of the terminal 1002 internal to the dielectric structure. Alternatively, the signal conductor 1004 may be exposed along an end of one of the dielectric cells 1006 with the terminal 1002 electrically connected to the exposed portion of the signal conductor 1004.

FIG. 21 illustrates a layered connector 1100 having signal conductors 1102. Any number of signal conductors 1102 may be provided, however a pair of signal conductors 1102 are shown in the illustrated embodiment. The layered connector 1100 includes dielectric cells 1104, 1106. The dielectric cells 1104, 1106 are manufactured from a semi-rigid material. The dielectric cells 1104, 1106 are flexible and are configured to be bent or routed between opposite ends 1108, 1110 thereof. The signal conductors 1102 are exposed on the dielectric cells 1104 at the ends 1108, 1110 for direct electrical connection to mating components, such as other layered connectors, circuit boards, cables, connectors, and the like.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means—plus-function format and are not intended to be interpreted based on 35 U.S.C. §112, sixth paragraph, unless and until such claim limitations expressly use the phrase “means for” followed by a statement of function void of further structure.

What is claimed is:

1. A layered connector comprising:
a transmission unit comprising a supporting dielectric cell and an exposing dielectric cell;
the supporting dielectric cell having a first surface supporting a signal conductor, the signal conductor extending to a mating end of the supporting dielectric cell;
the exposing dielectric cell being laminated to the first surface such that the signal conductor is positioned between the supporting dielectric cell and the exposing dielectric cell;
wherein the exposing dielectric cell is positioned on the first surface such that a portion of the first surface at the mating end and a portion of the signal conductor is exposed for direct electrical connection of the signal conductor to a mating component.

2. The layered connector of claim 1, wherein the signal conductor includes a covered portion and an uncovered portion, the covered portion being covered by the exposing dielectric cell and defining an internal signal layer of the transmission unit, the uncovered portion being exposed on the first surface beyond a recessed mating edge of the exposing dielectric cell for direct electrical connection of the signal conductor to a mating component.

3. The layered connector of claim 1, wherein a void is defined forward of a recessed mating edge of the exposing dielectric cell, the void exposing the first surface and the signal conductor at the mating end.

4. The layered connector of claim 1, wherein the supporting dielectric cell includes a finger extending beyond a recessed mating edge of the exposing dielectric cell, the finger extending to a mating edge, the finger defining the exposed portion of the first surface at the mating end.

5. The layered connector of claim 1, further comprising a second transmission unit stacked adjacent to the transmission unit.

6. The layered connector of claim 1, further comprising a second transmission unit comprising a second exposing dielectric cell and a second supporting dielectric cell supporting a second signal conductor, the supporting dielectric cell and the second exposing dielectric cell being formed integral as part of a common planar sheet, the exposing dielectric cell and the second supporting dielectric cell being formed integral as part of a common planar sheet, the signal conductor and the second signal conductor being arranged on a signal layer between the planar sheets.

7. The layered connector of claim 1, further comprising a second transmission unit comprising a second exposing dielectric cell and a second supporting dielectric cell supporting a second signal conductor, the transmission unit and the second transmission unit being oriented 180° with respect to one another such that the supporting dielectric cell is below the signal conductor and such that the second supporting dielectric cell is above the second signal conductor.

8. The layered connector of claim 1, further comprising a second transmission unit comprising a second exposing dielectric cell and a second supporting dielectric cell supporting a second signal conductor, the second transmission unit being stacked vertically on the transmission unit such that the signal conductor and the second signal conductor are on different layers of the layered connector.

9. The layered connector of claim 1, wherein the supporting dielectric cell includes a second surface opposite the first surface, the exposing dielectric cell includes a first surface facing the first surface of the supporting dielectric cell and a second surface opposite the first surface of the exposing dielectric cell, the layered connector further comprising an electrical shield layer deposited on at least one of the second surfaces, the electrical shield layer providing shielding for the signal conductor.

10. The layered connector of claim 9, wherein the electrical shield layer comprises a ground bridge extending forward from the corresponding supporting dielectric cell or exposing dielectric cell for making an electrical connection with the mating component.

11. The layered connector of claim 1, wherein the mating end, with the first surface and the signal conductor, defines a mating interface for mating with a corresponding transmission unit of the mating component.

12. The layered connector of claim 1, wherein the mating end, with the first surface and the signal conductor, defines a mating interface configured for direct mating with signal traces on a surface of a circuit board.

13. The layered connector of claim 1, further comprising an adhesive layer between the supporting dielectric cell and the exposing dielectric cell, the adhesive layer being coplanar with the signal conductor.

14. The layered connector of claim 1, wherein the signal conductor extends from the mating end of the supporting dielectric cell to a terminating end, the signal conductor being electrically connected to a terminating component at the terminating end.

15. The layered connector of claim 1, wherein the supporting dielectric cell and exposing dielectric cell are manufactured from a semi-rigid material allowing the layered connector to be flexible.

16. The layered connector of claim 1, wherein at least one of a thickness of the signal conductor, a width of the signal conductor, and dielectric constants of the supporting and exposing dielectric cells is selectively sized to achieve a similar characteristic impedance along the exposed portion of the signal conductor as along an unexposed portion of the signal conductor.

17. A method of manufacturing a layered connector, the method comprising:
providing a supporting dielectric cell;
depositing a signal conductor on a first surface of the supporting dielectric cell, the signal conductor extending to a mating end of the supporting dielectric cell; and
laminating an exposing dielectric cell to the supporting dielectric cell at the first surface such that the signal conductor is between the supporting dielectric cell and the exposing dielectric cell, the exposing dielectric cell having a void at the mating end of the supporting dielectric cell such that a portion of the first surface at the mating end is exposed and a portion of the signal conductor is exposed for direct electrical connection of the signal conductor to a mating component.

18. The method of claim 17, wherein said laminating comprises depositing an adhesive sheet on the first surface, positioning the exposing dielectric cell on the adhesive sheet and processing the structure to laminate the exposing dielectric cell to the supporting dielectric cell.

19. The method of claim 17, further comprising removing a portion of the exposing dielectric cell to define the void.

20. The method of claim 17, further comprising providing a first planar dielectric sheet and providing a second planar dielectric sheet, the first planar dielectric sheet being divided into at least one supporting dielectric cell, the second planar dielectric sheet being divided into at least one exposing dielectric cell.

21. The method of claim 17, wherein the first planar dielectric sheet is divided into at least one exposing dielectric cell and the second planar dielectric sheet is divided into at least one supporting dielectric cell.

22. A connector system comprising:
a first layered connector comprising a first transmission unit comprising a first supporting dielectric cell and a first exposing dielectric cell, the first supporting dielectric cell having a first surface supporting the first exposing dielectric cell and a first signal conductor positioned between the first supporting dielectric cell and the first exposing dielectric cell, the first exposing dielectric cell having a first void exposing a portion of the first surface at a mating end of the first supporting dielectric cell and exposing a portion of the first signal conductor; and
a second layered connector comprising a second transmission unit comprising a second supporting dielectric cell and a second exposing dielectric cell, the second supporting dielectric cell having a second surface supporting the second exposing dielectric cell and a second signal conductor positioned between the second supporting dielectric cell and the second exposing dielectric cell, the second exposing dielectric cell having a second void exposing a portion of the second surface at a mating end of the second supporting dielectric cell and exposing a portion of the second signal conductor;
wherein the first and second layered connectors are mated together at a interface such that the first surface faces the second surface and such that the first signal conductor directly engages the second signal conductor.

23. The connector systems of claim 22, wherein an air gap is defined by stacked thicknesses of the signal conductors between the first and second surfaces at the mating ends of the first and second supporting dielectric cells, at least one of the thicknesses of the signal conductors, widths of the signal conductors and spacing between the signal conductors is selectively sized to achieve a similar characteristic impedance in a region at the air gap as portions of the first and second signal conductors located between the corresponding supporting dielectric cells.

24. The connector systems of claim 22, wherein the first and second signal conductors have covered portions and uncovered portions, the covered portions being defined between the corresponding supporting and exposing dielectric cells, the uncovered portions being exposed by the voids, the uncovered portions being directly engaged when the first and second layered connectors are mated together, an air gap being defined by stacked thicknesses of the uncovered portions of the signal conductors, wherein the covered portions are covered by dielectric material having a dielectric constant selected to achieve similar characteristic impedance along the covered and uncovered portions of the first and second signal conductors.

25. The connector systems of claim 22, wherein the first and second layered connectors have electrical shields to provide electrical shielding for the signal conductors.

26. The connector systems of claim 25, wherein the electrical shield of the first layered connector is electrically connected to the electrical shield of the second layered connector.
